(19) United States
(12) Patent Application Publication
(10) Pub. No.: US 2013/0097169 A1
(43) Pub. Date: Apr. 18, 2013

(54) Personal Achievement and Recognition System and Method

(71) Applicant: Dumas Holdings LLC, Great Falls, VA (US)

(72) Inventor: Mark E. Dumas, Great Falls, VA (US)

(73) Assignee: Dumas Holdings LLC, Great Falls, VA (US)

(21) Appl. No.: 13/652,091

(22) Filed: Oct. 15, 2012

Related U.S. Application Data
(60) Provisional application No. 61/547,122, filed on Oct. 14, 2011.

(51) Int. Cl. G06F 17/30

(52) U.S. Cl. 707/737; 707/E17.046

(57) ABSTRACT

An electronic achievement and recognition system provides a software-based platform that allows users to receive, share, view and create achievements.

### REFERENCE TO RELATED APPLICATIONS

The present application claims the benefit of U.S. Provisional Application Ser. No. 61/547,122, filed Oct. 14, 2011 and entitled, “Personal Achievement and Recognition System and Method”, the disclosure of which is incorporated herein in its entirety.

### FIELD OF THE INVENTION

The present invention relates to personal achievement and recognition, and more particularly to a system and method for rewarding individuals with electronic tokens, achievements, or badges having a variety of uses.

### BACKGROUND OF THE INVENTION

Historically, people have been recognized for positive actions in a variety of ways and for a variety of reasons. For example, youth athletic programs may reward winners with trophies, Boy Scouts of America™ may award scouts with badges for achievement, and employers may reward employees with written recognition and/or a gift for desired performance. Microsoft's Xbox™ gaming system has the notion of achievements specific to its games.

### SUMMARY OF THE INVENTION

The present invention provides, among other things, an electronic achievement and recognition system. In one embodiment, the present invention provides a software-as-a-service (SaaS), web-based platform that allows people and entities (hereafter referred to as “users”) to receive, share, view and create achievements (hereafter referred to as “badges” but sometimes referred to as “medallions”).

In one embodiment, the present invention includes a badge authority for initiating individualized badge management programs for requesting organizations and their users. In one embodiment of the present invention, a requesting organization can establish a badge management program, enabling the organization to create, organize, manage rules for and deliver badges to selected or participating members of that organization's badge program. A member or user of that organization can then receive one or more badges for a variety of reasons, as authorized and determined by the managing organization. In one embodiment of the present invention, a user cannot bestow a badge upon him or herself, but can request that a badge be bestowed upon him or herself from a vetted entity. For example, an alumnus of a university can request a “diploma” badge from the university using the present invention, but only the university can actually issue or bestow the badge upon the alumni.

Each user can be provided with tools in accordance with the present invention to manage and customize his or her badges. For example, a user can view their collection of badges, customize the layout and establish public/privacy options by badge or by badge tag or by badge authorizer. A user can also print the badge layout for various reasons, request a high resolution poster, or even request a 3-D printing or actual tangible representation of a badge where permissible.

Each badge is unique in that it contains a unique identifier for tracking within the invention. For example, a “Triple Kill” badge in Microsoft's Halo III first-person shooter game might have the unique identifier of “triplekill.halo3.xbox.microsoft.com”. This unique identifier (and index) helps ensure that there are no badge “collisions” and misrepresentations, as only a registered administrator from Microsoft.com can create and own badges in a subdomain in accordance with the present invention. Further, badges can be provided with individual URL landing pages on a primary host site associated with the present invention. In one embodiment of the present invention, the landing page can show, for example, summary statistics for how many users have the same badge as a percentage of users, the momentum of the badge in terms of recent awards (e.g., a graph over time) and geographic charts representing badge concentration and badge demographics. In one embodiment of the present invention, badges can have conversations or posted comments from users, with ratings about the page and optional links to social media sites, such as Facebook™, for example. Badge URLs can also be provided with tiny URLs for shortcuts for twitterversers. While vetted organizations can bestow organization-specific badges, playful badges can be created by users to bestow on others, such as “#1 Husband” or “#1 Wife”, for example. Users can further bestow a certain number of badges for free using virtual credits in accordance with one aspect of the present invention. Additional badges can optionally require the purchase of credit points using promotions such as from payment providers such as PayPal™, for example. In one embodiment of the present invention, users or organizations can create badges using a web-based template generator, or choose from pre-fabricated badges, for example. Users or organizations can also upload a graphic in high resolution to represent the natural badge, and a software application associated with the present invention can also shrink it down to a thumbnail view, for example.

As discussed above, badges can be created by users and/or organizations in accordance with the present invention. In one embodiment of the present invention, badges contain metadata that can be supplied, such as a timespan representation (e.g. Jul. 1, 2014-Jul. 1, 2015) or point in time (e.g. Jul. 4, 2008), for example. It can also contain one or more URLs to external sites, such as a Wikipedia™ page or company website, for example. Users can register directly into a host site provided as part of the present invention, and can be related to one or more organizations. In this way, the present invention facilitates the natural separation of a user from an organization, such that a user can obtain, display and organize badges from a large variety of different entity-types, including employers, social media connections, philanthropic organizations, sports clubs, hobby groups and other types of entities. In one embodiment of the present invention, registration can be accelerated by providing Facebook™, LinkedIn™, JabFab™, or Twitter™ credentials, and subsequently users created otherwise can provide Facebook™, LinkedIn™, JabFab™, and/or Twitter™ associations. In another embodiment of the present invention, registration can be done by organizations, as organizations have default emails for which to create a user. In this way, a user may become registered by another and prior to attempting to manage any individually-earned badges through the system of the present invention.

### BRIEF DESCRIPTION OF THE DRAWINGS

FIG. 1 shows a schematic representation of one embodiment of the present invention.

FIG. 2 shows an exemplary display in accordance with one embodiment of the present invention.

FIG. 3 shows a schematic diagram representing relationships among users, organizations and badges in accordance with one embodiment of the present invention.

### DESCRIPTION OF EMBODIMENTS OF THE PRESENT INVENTION

In one embodiment, the platform of the present invention provides a community intersection of users, organizations, and achievements or “badges” in a way that provides universal appeal, free and engaging user experiences and user and organizational up-sell opportunities.

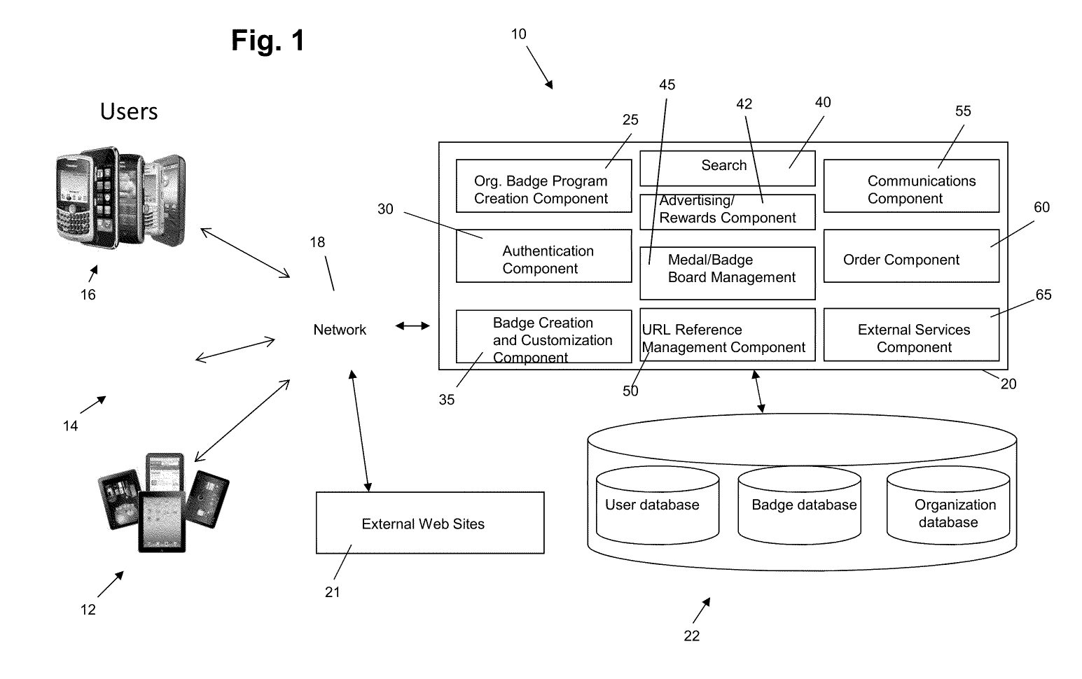

As shown in FIG. 1, the present invention provides a system 10 that is accessible by various types of users, including organizations and individual users. It will be appreciated that the system 10 of the present invention can comprise a network of computers coupled together (e.g., by way of an Ethernet connection), a multi-tiered architecture, or any other suitable means for providing software as a service (“SaaS”). The system 10 further can comprise or be controlled via cloud computing or “on-demand” computing means. As will be appreciated by those of ordinary skill in the art, the term “cloud computing” refers to a computing paradigm in which tasks are assigned to a combination of connections, software and services accessed over a network. This network of servers and connections is collectively known as “the cloud.” Computing at the scale of the cloud allows users to access supercomputer-level power. Using a thin client or other access point (e.g., devices 12, 14, 16), users can reach into the cloud for resources as they need them.

Among other things, the present invention permits the users to receive, share, view and create badges, using any of a variety of clients 12, 14, 16. The clients can comprise, for example, one or more conventional desktop or laptop computers or workstations 14, as well as tablet computing devices 12 and mobile communications devices 16 (e.g., “smart phones”). The clients 12, 14, 16 can access system 10 by way of a network 18. By use of the term “network”, it will be appreciated that the present invention is not limited to any particular wireline or wireless network, such as local area networks (LANs), metropolitan area networks (MANs), or wide area networks (WANs). Network 18 can comprise the Internet, in one embodiment of the present invention, but it can also comprise intranets, extranets, and virtual private networks (VPNs) and the like. In accordance with embodiments of the present invention, system 10 can suitably be comprised of an application 20, and a database or databases 22.

As further shown in FIG. 1, the application 20 can comprise a plurality of components 25, 30, 35, 40, 45, 50, 55, 60 and 65 with software using a module-based architecture. Component 25 comprises a plurality of instructions for the purposes of creating organizational badge programs, as described above. Component 30 comprises a plurality of instructions to authenticate users, as described elsewhere herein. Component 35 comprises a plurality of instructions to permit users to create and customize badges, as described elsewhere herein. Component 40 comprises a plurality of instructions to permit users to search for and retrieve information on relevant badges and/or badge programs run by particular organizations. Component 42 comprises a plurality of instructions to permit third party advertising networks to place targeted advertisements into the user interfaces based on the behaviors and award types the system intelligently and automatically recognizes, as described elsewhere herein.

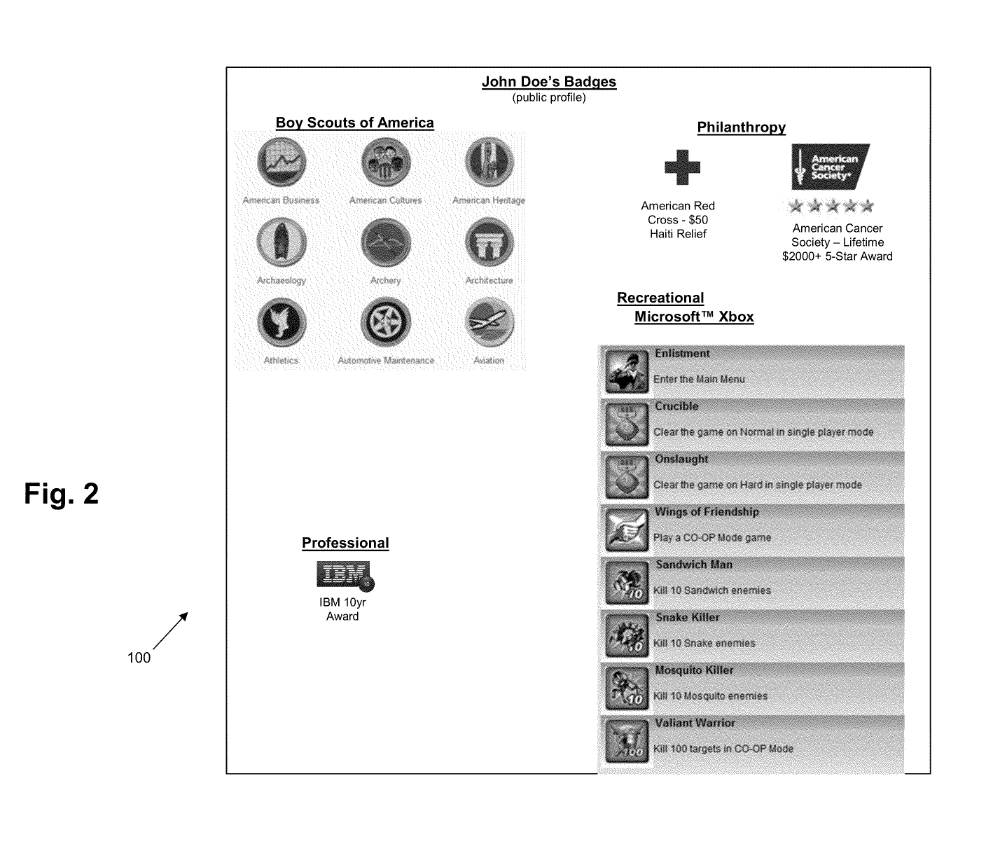

Component 45 comprises a plurality of instructions permitting users to manage badge boards, such as described elsewhere herein. For instance, component 45 can permit a user to set badge profiles (e.g., private, public, protected) as well as to design the layout of a badge board for other users to see. FIG. 2 illustrates a sample display or badge board 100 that might be associated with a single user (“John Doe”) in his public profile, for example. Such a display would be comparable to a display of badges on a military officer, for example. Component 50 comprises a plurality of instructions for managing URL references for badges, in accordance with the description elsewhere herein. Component 55 comprises a plurality of instructions to permit communications among users, as well as with external web sites 21 and external functionalities, such as “friend” programs and other programs as described elsewhere herein. Component 60 comprises a plurality of instructions to permit users to order different types of badge representations as illustrated elsewhere herein. Component 65 comprises a plurality of instructions for incorporating external services as required by the present invention, such as, for example, salesforce™ software, Microsoft Xbox™ software and others as illustrated elsewhere herein. It will be appreciated that each of the above components can further interact with user database, badge database and organization database (collectively 22) as needed in performing the operations available to each component.

As described elsewhere herein, the platform of the present invention allows organizations to control and administer achievements in the form of badges to users. The organizations may set privacy options, which can be set more restrictively by users, for example. The users, many of which may be employees, students, or members of these organizations, can view, print, and share their achievements and/or badges.

As users exist separately from the organizations in which they are involved, the system of the present invention ensures that the correct recipient receives an achievement. In one embodiment of the present invention, this can be controlled via email authentication or username/password authentication. For example, all donors to the American Red Cross can be asked for an e-mail address to which their donation receipt will be sent. Such a process provides a primary key (i.e., the e-mail) which can be used for sending a digital achievement message to, as well as a way in which to identify an existing platform-enrolled user. In one embodiment of the present invention, users can be identified by numerous linked e-mails to their account, as well as other logins (e.g., Facebook™, LinkedIn™)

In one embodiment of the present invention, organizations can post achievements to users who are not enrolled or who never enroll into the platform. If a user enrolls later in time, whether by invitation or not, then the present invention can permit the user to authenticate one or more e-mails, for example, and then “claim” the achievements or badges.

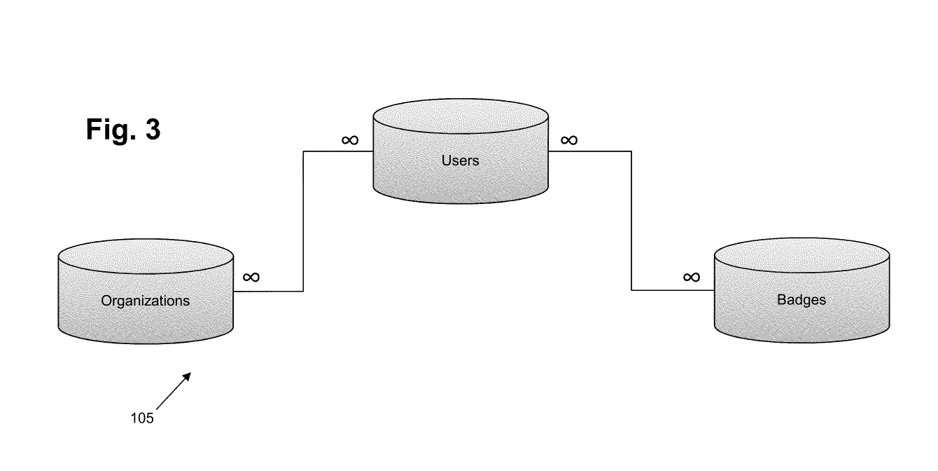

FIG. 3 shows diagram 105, which illustrates an exemplary aspect of separating the users and badges from the organizations to achieve the notion of an open “badgespace” for any particular user.

Table 1 illustrates a series of e-mail addresses that a user might employ with the present invention One or more e-mail addresses might be self-registered and one or more e-mail addresses might be registered by outside parties in accordance with aspects of the present invention.

TABLE 1

| User | | | |
|---|---|---|---|
| Id. # | Primary e-mail | Secondary e-mail | Tertiary e-mail |
| 1 | mdoe@someco. | mdoe@secondco. | mdoe@homemail. |
| . | com | com | com |
| . | | | |
| . | | | |

The present invention can be used to recognize and/or reward employees for tenure milestones. For example, a company's human resources (HR) department can use the present invention to reward 1-year, 5-year, and 10-year employees with badges using the present invention by linking their HR records to company e-mail addresses of the tenured users. When the e-mail goes out, 100,000 employees might then register with the platform of the present invention. As another example, if the American Cancer Society issues a medal for all donations over $50 in a certain year, another group of perhaps thousands of people might get a notice, some of which may also be members of the company group.

As a further example, a Non-Profit Organization A can have a $100 donation appreciation badge that goes to all users who donate $100 or more. The generic set of badgespaces for this award can be tied to a unique identifier such as 100donor.Non-ProfitA.com, and users can be notified via e-mails from the Non-Profit Organization A that they have received the badge. Further, there can be a unique identifier for a single badge to be awarded to a single user, such as “Volunteer of the Year”.

In one embodiment of the present invention, a many-to-many relationship exists between users and organizations, except badgespaces may be linked only to a single organization via the hierarchy. This is illustrated by the Non-Profit Organization A example above, whereby the organization can have multiple badges, and there can be multiple users capable of achieving one or more badges. In one embodiment of the present invention, badges themselves can be user generated via an online or “web” wizard given various templates. Further, the badges can have a landing page uniform resource locator (URL) at the level in which they exist in the hierarchy. For example, the “Triple Kill” badge in Halo can have an index of triplekill.halo.xbox.games.Microsoft.com. This can be expressed in URL form and can have a tiny URL, for example. It is contemplated that each badge can have a Facebook™-like button, JabFab™ button, and other types of links (e.g., digg, rss feed, etc).

Badges can come in all shapes and sizes and can be provided with a common theme or layer as a baseline on top of which creative elements can be placed. For example, one badge layer can simulate a general's chest, or a cub scout. Badges can have a one-to-many relationship with users, or a one-to-one relationship with users, for example. In a one-to-many relationship, one badge can be awarded to multiple users. For example, a company may have thirty employees who have been with the company for ten or more years. The company badge would thus be the same badge awarded to multiple recipients. On the other hand, a company may have an employee-of-the-month badge that is only awarded to one employee at a time. In such a situation, there is a one-to-one relationship between that badge and a user.

As described above, users can be provided with URLs to their badge pages. In a further embodiment of the present invention, badges can have an organizationally controlled primary key for independent reference. Badges can also be provided with graphics, an external URL reference, and a point value as defined by the controlling organization. Badges can also have a tag field to help enable badge searches. Badgespaces can be provided with labels and generic data as well.

In one embodiment of the present invention, organizations can designate badges as public or private or protected. “Protected” means anyone in the organization can see the badge, but members of the public cannot. “Private” means only the user can see the badge.

In using the present invention, organizations can administer badges and achievements by verifying themselves at a top level with an administrative point of contact (POC) and a registration contract. Once the top level administrator has been identified, the administrator can add additional users and sub-domain controllers for the organization. For example, multiple lines of businesses may want their own administrators, yet while keeping a global HR administrator.

In one embodiment of the present invention, consistent with the above description, achievement spaces can be identified by domain name-like spaces. For example, the top level “Software Company” controller can be identified by owning the softwarecompany.com achievement domain. The research and development business line achievement space could be identified by rand.softwarecompany.com. The sports gaming administrator and badge space for this company could be identified by sports.games.softwarecompany.com. The badge space for a hockey game might be identified such as hocket.sports.games.softwarecompant.com, for example. A public user may be able to access these spaces through a central web site, such as www.accoladia.com, for example. Specifically for the hockey reference above, the public access can appear as www.accoladia.com/com/softwarecompany/games/sports/hockey, for example. Such a directory structure prevents “collisions” in all of the organizations that exist on the internet and allows for unlimited possibilities. Because the administrator of the softwarecompany.com account is verified, this will also ensure that badges created by the software company are indeed controlled by the software company, and not someone else.

It will be appreciated that the organizational user interface (UI) can be separated from the core platform logic. In one embodiment of the present invention, the organizational administration UI is a default interface that accesses a common application programming interface (API). In this way, organizations and third parties can create their own interfaces to the platform including integration into other software such as salesforce.com, Microsoft XBox Live™, and so forth. The API can provide for secure, password-protected access to common functions, such as to grant or revoke badges to a list of emails. Common API functions include, for example:
create project (i.e., badge domain), e.g., create games.softwarecompany.com under softwarecompany.com.
delete project (e.g., through a “soft” delete so permanent records are kept)
batch add users/consumers to a project, specifying badges they should each have
linking one or more users to a badgespace, with one or more medals globally or individually.
unlinking one or more users from a badgespace, which automatically soft deletes any badges granted at that level or below
adding or removing administrators for badgespaces

In one embodiment of the present invention, there can be a spreadsheet wizard or comma-separated value (CSV) wizard to ingest data in batch mode in a similar fashion. Fields can be, for example: email, badgeid, [pt value], [date], [public/private/protected], where the bracketed fields are optional. Optional fields are defaulted to 0 for point value, the current date for date, and public for privacy settings.

In one embodiment of the present invention, conversations can occur at the generic badge level, such as at the “2011 American Red Cross Donor badge”. They can also be at the users' page. When a badge is accepted, it can be auto tweeted. Badges can also be overridden as private. Users can control if only friends can see their badges, or if those in the organization from which the badge came from can see their badges. Either of these cases is known as a variant of “protected”, on one embodiment of the present invention. In another embodiment of the present invention, friends can be defined through other social media sites, for example, such that the central web site does not need to concern itself with “friend” associations.

In one embodiment, users can participate in rewards and loyalty programs offered to badge recipients at large, or offered through organizations to their respectively linked users. Since badges optionally have point values, a badge program for Software Company employees might include some sort of Software Company award—e.g., a $100 shopping spree given by the company—to its employees that achieve a certain number of points related to Software Company achievements. Alternatively, the Software Company described above might offer awards to its employees that achieve a certain number of specific points in other domains like philanthropy, which is such a case that a vetted organization wants to incentivize civic, fitness, or social responsibility.

Data mining and advertising programs are additional aspects of the present invention, whereby the system of the present invention can allow for third party advertising networks to place targeted advertisements into the user interfaces based on the behaviors and award types the system intelligently and automatically recognizes. The system can further assist third party systems in the ad placement on the badge URLs as well, based upon recognizing certain demographics, locales, or other statistically significant segmentations. Users can “opt-in” or “opt-out” of email solicitation programs where the central system allows access to user e-mails based on their preferences and demographics.

In considering the present disclosure, persons of ordinary skill in the relevant art will appreciate that other arrangements and components can be used without departing from the spirit of the present invention and embodiments described herein. It will also be appreciated that each specific component described herein includes all technical equivalents that operate in the same or similar manner to accomplish the same or similar purpose. Therefore, the description and examples herein are not to be considered as limiting and/or the only examples of the present invention. Further, embodiments of the present invention can include computing devices and other relevant devices for performing the operations disclosed herein. A device for employing, or use with, the present invention can be specially constructed for the desired purposes, or can comprise a general-purpose computer or similar device selectively activated or reconfigured by a program stored in the device.

The present invention can also be implemented in one or a combination of hardware, firmware, and software. They may be implemented as instructions stored on a non-transitory machine- or computer-readable medium, which may be read and executed by a processor and/or computing platform to perform the steps and operations described herein. A machine- or computer-readable medium can include read only memory (ROM), random access memory (RAM), magnetic disk storage media, optical storage media and flash memory devices, for example. Embodiments of the present invention can be directed to such computer program products, such as, for example, removable storage drives, and/or a hard disk installed in hard disk drive.

Further with regard to the present disclosure, an algorithm can be considered a self-consistent sequence of steps, operations or actions that lead to a desired result. These include physical manipulations of physical quantities. It will be appreciated that these quantities can take the form of electrical or magnetic signals capable of being stored, communicated, transferred, deleted, combined, compared, and otherwise manipulated, and further can be conveniently referred to as elements, items, values, terms, points, symbols, characters, numbers and bits, for example.

It will further be appreciated that terms such as “processing”, “computing”, “calculating”, “determining”, and other similar terms refer to the steps or actions of a computer or computing system, for example, that manipulate or otherwise transform data represented as physical, such as electronic, quantities within the computing system's registers or memory(ies) into other data similarly represented as physical quantities within the computing system's memory(ies), registers or other such information storage, transmission or display devices. Similarly, the term “processor” can comprise any device or portion of a device that processes electronic data from registers or memory(ies) to transform that electronic data into other electronic data that may be stored in registers or memory(ies). A “platform” can comprise one or more processors.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A system for managing electronic representations of achievement, comprising:
at least one data storage device operable to store computer-readable instructions;
at least one computer processor operable to execute the computer-readable instructions; and
a set of computer-readable instructions operable to:
via an organizational badge program management component, facilitate the creation of two or more individual electronic badge management programs;
via a badge creation and customization component, facilitate the creation of one or more badges within each of the two or more organizational badge management programs, wherein each of the one or more badges has a unique badgespace associated therewith in the respective badge management program; and
via a badge board management component, facilitate the display of one or more badges and user access control for the one or more badges.

2. The system of claim 1 wherein one of the one or more badges of a first of the badge management programs is the same as one of the one or more badges of a second of the badge management programs.

3. The system of claim 1 wherein a first of the badge management programs can associate a first user e-mail address with a badge, and wherein a second of the badge management programs can associate a second user e-mail address with a badge, and wherein the first user e-mail and the second user e-mail belong to the same user.

4. The system of claim 1 wherein the set of computer-readable instructions are further operable to, via a communications component, facilitate the sharing, viewing, delivery and reception of the one or more badges.

5. The system of claim 1 wherein each badgespace is identified by a domain name.

6. The system of claim 1 wherein the set of computer-readable instructions are further operable to, via a URL reference management component, facilitate the establishment of specific electronically-referenceable pages dedicated to one or more badges.

7. The system of claim 1 wherein the set of instructions are further operable to, via a search component, facilitate the discovery of one or more badges or badge management programs.

8. The system of claim 1 wherein the set of instructions are further operable to establish a one-to-many relationship as between a first of the one or more badges and user recipients of the first badge.

9. The system of claim 1 wherein the set of instructions are further operable to establish a many-to-many relationship as between the one or more badges and user recipients of the one or more badges.

10. The system of claim 1 wherein at least one of the badge management programs can award a badge to a user and associate the badge with an e-mail address associated with the user, but wherein the user is not enrolled with the badge management program.

11. A method for managing electronic representations of achievement, comprising:
causing at least one processor to execute a plurality of instructions stored in at least one memory device for facilitating the creation of two or more individual electronic badge management programs;
causing at least one processor to execute a plurality of instructions stored in at least one memory device to facilitate the creation of one or more badges within each of the two or more organizational badge management programs, wherein each of the one or more badges has a unique badgespace associated therewith in the respective badge management program; and
causing at least one processor to execute a plurality of instructions stored in at least one memory device to facilitate the display of one or more badges and user access control for the one or more badges.

12. The method of claim 11 wherein one of the one or more badges of a first of the badge management programs is the same as one of the one or more badges of a second of the badge management programs.

13. The method of claim 11 wherein a first of the badge management programs can associate a first user e-mail address with a badge, and wherein a second of the badge management programs can associate a second user e-mail address with a badge, and wherein the first user e-mail and the second user e-mail belong to the same user.

14. The method of claim 11 wherein the set of computer-readable instructions are further operable to, via a communications component, facilitate the sharing, viewing, delivery and reception of the one or more badges.

15. The method of claim 11 wherein each badgespace is identified by a domain name.

16. The method of claim 11 wherein the set of computer-readable instructions are further operable to, via a URL reference management component, facilitate the establishment of specific electronically-referenceable pages dedicated to one or more badges.

17. The method of claim 11 wherein the set of instructions are further operable to, via a search component, facilitate the discovery of one or more badges or badge management programs.

18. The method of claim 11 wherein the set of instructions are further operable to establish a one-to-many relationship as between a first of the one or more badges and user recipients of the first badge.

19. The method of claim 11 wherein the set of instructions are further operable to establish a many-to-many relationship as between the one or more badges and user recipients of the one or more badges.

20. The method of claim 11 wherein at least one of the badge management programs can award a badge to a user and associate the badge with an e-mail address associated with the user, but wherein the user is not enrolled with the badge management program.
